(19) United States
(12) Patent Application Publication
(10) Pub. No.: US 2025/0366962 A1
(43) Pub. Date: Dec. 4, 2025

(54) CONTROL METHOD OF ORAL IRRIGATOR AND ORAL IRRIGATOR

(71) Applicant: NINGBO SEAGO ELECTRIC CO., LTD., Ningbo City (CN)

(72) Inventors: Zhuting Dong, Ningbo City (CN); Zhimin Liu, Ningbo City (CN); Yanzhong Cai, Ningbo City (CN); Yuli Wang, Ningbo City (CN)

(21) Appl. No.: 19/033,522

(22) Filed: Jan. 22, 2025

(30) Foreign Application Priority Data
Jun. 4, 2024 (CN) 202410718381.0

(51) Int. Cl. A61C 17/02

(52) U.S. Cl. CPC A61C 17/02

(57) ABSTRACT

The present disclosure provides a control method of an oral irrigator and an oral irrigator, wherein the oral irrigator includes a normal working mode and a spot spray working mode. The oral irrigator is capable of switching between the normal working mode and the spot spray working mode. In the normal working mode, the oral irrigator continuously sprays water. In the spot spray working mode, the oral irrigator sprays water in a pulsed manner, with a pause duration between two water sprays.

### CROSS-REFERENCES TO RELATED APPLICATIONS

The present disclosure claims priority to Chinese Patent Application No. 2024107183810, entitled “CONTROL METHOD OF ORAL IRRIGATOR AND ORAL IRRIGATOR” filed on Jun. 4, 2024 with the Chinese Patent Office, the entire contents of which are incorporated herein by reference.

### TECHNICAL FIELD

The present disclosure belongs to the field of oral health care, and in particular to a control method of an oral irrigator, and an oral irrigator.

### BACKGROUND ART

The oral irrigator can use a water pump to draw water from the water tank to the nozzle to form a jet stream, in order to rinse the mouth and teeth of the user. Compared to a toothbrush, the oral irrigator can more thoroughly remove dental plaque and more scientifically and effectively avoid oral diseases, including gingivitis, periodontal disease, and gum bleeding, thus gradually gaining favor from consumers.

The existing oral irrigators spray water continuously during use, but sometimes the spray head is not aligned with the position that needs cleaning, leading to excessive use of mouthwash and causing waste of the mouthwash.

### SUMMARY

The present disclosure aims to provide a control method of an oral irrigator to solve the problem of excessive mouthwash usage in the existing oral irrigators. The present disclosure further provides an oral irrigator.

The embodiment of the present disclosure provides a control method of an oral irrigator, wherein the oral irrigator includes a normal working mode and a spot spray working mode. The oral irrigator is capable of switching between the normal working mode and the spot spray working mode.

In the normal working mode, the oral irrigator continuously sprays water.

In the spot spray working mode, the oral irrigator sprays water in a pulsed manner, with a pause duration between two water sprays.

In at least one embodiment, the spot spray working mode includes a manual mode and an automatic mode, and the oral irrigator is capable of switching between the manual mode and the automatic mode;
the oral irrigator is provided with a first button and a second button;
in the manual mode, when the second button is pressed, the oral irrigator sprays water, and when the second button is released, the oral irrigator stops spraying water; and
in the automatic mode, the oral irrigator automatically sprays water for a period of time, pauses for a period of time, and then automatically sprays water again, and a cycle repeats.

In at least one embodiment, in the normal working mode and the automatic mode, a short press of the first button stops the oral irrigator from spraying water.

In at least one embodiment, after the oral irrigator is powered on, a short press of the second button activates the normal working mode of the oral irrigator.

After the oral irrigator is powered on, or after a short press of the first button in the normal working mode to stop spraying water, a double-click of the second button activates the spot spray working mode.

In at least one embodiment, in the spot spray working mode, the double-click of the second button enables the oral irrigator to switch between the manual mode and the automatic mode.

In at least one embodiment, the oral irrigator defaults to the manual mode when the spot spray working mode is activated.

In at least one embodiment, the oral irrigator includes an indicator light assembly, and when the oral irrigator switches modes, the indicator light assembly is configured to indicate a result of a mode switch.

In at least one embodiment, the oral irrigator includes a voice module, and when the oral irrigator switches modes, the voice module is configured to announce the result of the mode switch.

The present disclosure further provides an oral irrigator, wherein the oral irrigator adopts the control method of an oral irrigator according to any one of the above technical solutions.

The oral irrigator includes a first tank, a second tank, a selection valve, and a water pump, wherein the selection valve is connected to an inlet of the water pump.

In the spot spray working mode, the selection valve enables the water pump to communicate with the first tank; and in the normal working mode, the selection valve enables the water pump to communicate with the second tank.

In at least one embodiment, the oral irrigator includes a spray head.

The spray head includes a normal spray head and a spot spray head, wherein a liquid sprayed from the normal spray head is in a form of a column, and a liquid sprayed from the spot spray head is in a form of a shower.

In the normal working mode, the oral irrigator is replaced with the normal spray head, and in the spot spray working mode, the oral irrigator is replaced with the spot spray head.

It can be understood that in the present disclosure, except where the distinction between water and mouthwash is specifically emphasized, “spraying” is used in most cases to refer to spraying not only water but also other cleaning liquids, such as mouthwash. Therefore, “spraying” should not be mechanically understood as spraying only pure water or tap water.

By adopting the above technical solutions, in the spot spray working mode, the oral irrigator can spray water in a pulsed manner, saving mouthwash while maintaining the cleaning effect.

### BRIEF DESCRIPTION OF DRAWINGS

FIG. 1 illustrates a schematic structural diagram of an oral irrigator according to the embodiment of the present disclosure;

FIG. 2 illustrates a schematic structural diagram of an oral irrigator from another angle according to the embodiment of the present disclosure;

FIG. 3 illustrates a schematic diagram of a pipeline connection of an oral irrigator according to the embodiment of the present disclosure; and

FIG. 4 illustrates a schematic diagram of a control method of an oral irrigator according to the embodiment of the present disclosure.

### REFERENCE NUMERALS

100 oral irrigator; 101 oral irrigator main body; 102 oral irrigator spray head; 103 indicator light assembly;
1 first button; and
2 second button.

### DETAILED DESCRIPTION OF EMBODIMENTS

To further clarify the above objectives, features, and advantages of the present disclosure, the specific embodiments of the present disclosure will be described in detail below with reference to the drawings. In addition to the embodiments described in this section, the present disclosure can also be implemented in other different ways. Without departing from the spirit of the present disclosure, those skilled in the art can make corresponding modifications, variations, and substitutions. Therefore, the present disclosure is not limited to the specific embodiments disclosed in this section. The scope of protection of the present disclosure should be determined by the claims.

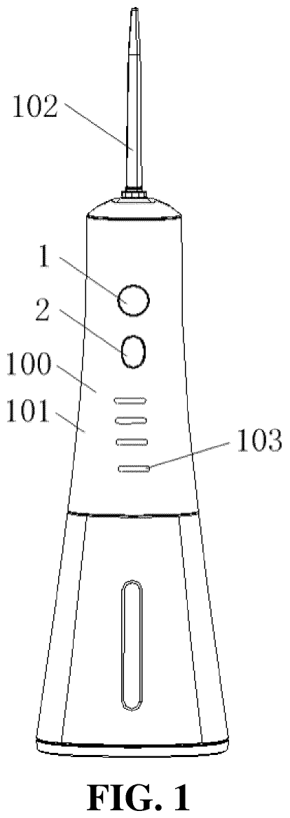

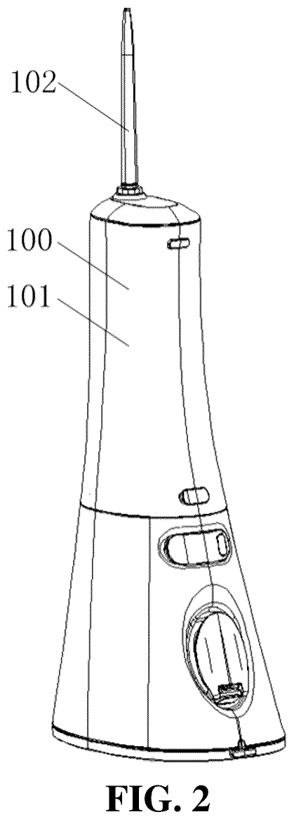

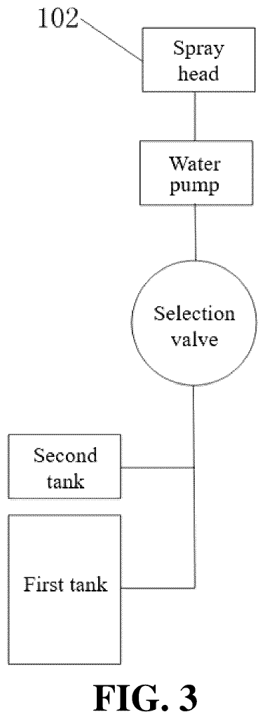

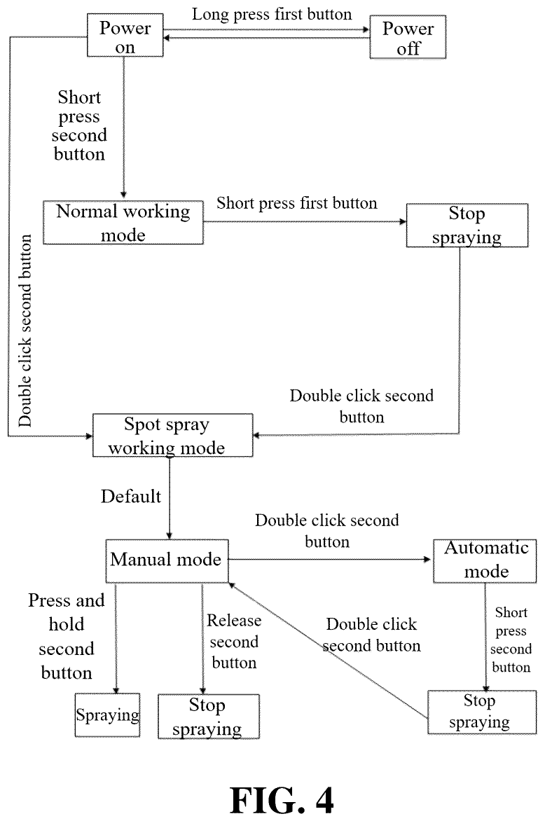

As shown in FIG. 1 to FIG. 4, the embodiment of the present disclosure provides an oral irrigator 100, and the oral irrigator 100 includes an oral irrigator main body 101 and a spray head 102. The spray head 102 can be detachably mounted to the front end (the upper end in FIG. 1 and FIG. 2) of the oral irrigator main body 101, and the spray head 102 can be replaced.

The oral irrigator main body 101 can include a first tank and a second tank, with the first tank and the second tank positioned at the rear end (the lower end in FIG. 1 and FIG. 2) of the oral irrigator main body 101.

The oral irrigator main body 101 includes a selection valve and a water pump. The first tank (clean water tank) is configured to store water, and the second water tank (mouthwash tank) is configured to store mouthwash.

The first tank and the second tank can be connected to the selection valve; the selection valve can be connected to the inlet of the water pump; and the spray head 102 can be connected to the outlet of the water pump. The selection valve allows the water pump to communicate with the first tank and/or the second tank, and the water pump can pump liquid from the first tank and/or the second tank to the spray head 102 for spraying.

The oral irrigator can have a spot spray working mode and a normal working mode.

In the spot spray working mode, the selection valve enables the water pump to communicate with the first tank; and in the normal working mode, the selection valve enables the water pump to communicate with the second tank. However, the present disclosure is not limited to this, and the user can freely select the tank used for the spot spray working mode and the normal working mode. In some possible embodiments, the water pump can simultaneously draw liquid from both tanks.

The oral irrigator main body 101 is provided with a first button 1 (also referred to as the power button) and a second button 2 (also referred to as the mode switch button).

It can be understood that in FIG. 1, the shapes and mounting positions of the first button 1 and the second button 2 are shown schematically, and the shapes and mounting positions of the first button 1 and the second button 2 are not limited by the specific embodiments.

The present disclosure also provides a control method of an oral irrigator, and the oral irrigator has a normal working mode and a spot spray working mode. In the normal working mode, the oral irrigator continuously sprays water, and in the spot spray working mode, the oral irrigator sprays water in a pulsed manner.

In the following description, a long press can refer to pressing continuously for, e.g., greater than or equal to 3 seconds, and a short press can refer to pressing continuously for, e.g., less than 3 seconds. It can be understood that 3 seconds is merely an example or default value, and this value can be set according to actual needs.

### Normal Working Mode

A long press (e.g., pressing for 3 seconds) of the first button 1 can power on the oral irrigator 100. After the oral irrigator is powered on, a short press of the second button 2 can activate the normal working mode of the oral irrigator. In the normal working mode, the oral irrigator can draw water from the first tank (clean water tank) through the water pump and continuously spray water through the spray head 102. After a short press of the first button 1 again, the water pump stops working, and the spray head 102 of the oral irrigator 100 stops spraying water.

### Spot Spray Working Mode

After powering on the oral irrigator, or after a short press of the first button 1 to stop spraying water in the normal working mode, a double-click of the second button 2 within a preset time period (e.g., 3 seconds) can switch the oral irrigator to the spot spray working mode. Once switched to the spot spray working mode, the oral irrigator can obtain the initial water pressure and target water pressure corresponding to the spot spray working mode. The selection valve can control the water pump to communicate with the second tank (mouthwash tank). The water pump starts to increase the pressure to the initial water pressure and gradually increases the water pressure within the preset time period until the target water pressure is reached, thus completing one pulse spray action. The oral irrigator repeatedly performs the above operation in the spot spray working mode.

In the spot spray working mode, the oral irrigator can produce a pulsed water flow. The water pump produces the high-pressure pulsed water to rinse the gaps between teeth, gingival sulcus, and other areas, thus providing ideal cleaning strength and good cleaning results.

The preset time period is provided for the user to move the oral irrigator to align the spray head 102 with the cleaning position. The user can align the nozzle with the position in the oral cavity that needs to be cleaned according to the usage habits of the users. Once switched to the spot spray working mode, the oral irrigator allows the user a duration (the preset time period) to align the spray head 102 with the cleaning position.

The user can select the spot spray working mode based on actual needs. In the spot spray working mode, there is a pause between two sprays, which allows the user to align the cleaning position. Compared to the normal working mode, the spot spray working mode helps save mouthwash while maintaining the cleaning effect.

The oral irrigator can switch between the normal working mode and the spot spray working mode in the following manner.

A long press (e.g., 3 seconds) of the first button can turn on the oral irrigator. A short press of the second button can switch the oral irrigator to the normal working mode. A double-click of the second button within a preset time period (e.g., 3 seconds) can switch the oral irrigator to the spot spray working mode.

The spot spray working mode comprises a manual mode and an automatic mode, and the oral irrigator is capable of switching between the manual mode and the automatic mode.

### Manual Mode

After the spot spray working mode is activated by the oral irrigator, the default mode can be the manual mode. In manual mode, pressing and holding the second button 2 can make the water pump work and the spray head 102 sprays water. Once one position is cleaned, releasing the second button 2 can stop the water pump from working and the spray head 102 stops spraying water. The user then aligns the spray head 102 with the next cleaning position, and presses and holds the second button 2 to make the spray head to continue spraying water, and this process will repeat.

### Automatic Mode

Within a preset time period (e.g., 3 seconds), a double-click of the second button 2 can switch from the manual mode to the automatic mode, and the double-click of the second button 2 can realize the anti-stay function to prevent maloperation.

In the automatic mode, the oral irrigator can be moved so that the spray head 102 sprays water to the position that needs to be cleaned. After a preset time period (e.g., 2 seconds), the water pump will automatically pause for a period of time (e.g., 1 second), and the spray head 102 will stop spraying water. During this period of time, the spray head 102 of the oral irrigator can be aligned with the next cleaning position. Then the water pump resumes working, and the spray head 102 sprays water automatically. This cycle repeats. After pressing the first button 1, the oral irrigator will stop working. Once the oral irrigator stops working, a double-click of the second button 2 within a preset time period (e.g., 3 seconds) can switch from the automatic mode back to the manual mode.

Furthermore, in the automatic mode, the spray duration and pause duration can be customized. For example, the default spray duration can be set to 2 seconds, and the pause duration can be set to 1 second.

Further, the oral irrigator further includes a voice module, and when the oral irrigator switches modes, the voice module is configured to announce the result of the mode switch. This enhances user experience and reduces operational errors. For instance, the voice module can broadcast messages such as “switched to normal working mode”, “switched to manual mode”, or “switched to automatic mode”.

Further, as shown in FIG. 1, the oral irrigator further includes an indicator light assembly 103. The indicator light assembly 103 can include multiple indicator lights. When the oral irrigator switches modes, the corresponding indicator light lights up to indicate the result of the switching mode. For example, the indicator light assembly 103 can include a normal working mode indicator light, a spot spray working mode indicator light, a manual mode indicator light, and an automatic mode indicator light.

Furthermore, the oral irrigator can connect to a mobile phone, allowing the application to access the current working mode and/or the parameter settings for the current working mode of the oral irrigator (e.g., long press duration, spray duration in automatic mode, target water pressure, and initial water pressure).

Additionally, the voice broadcast function is enabled by default but can be disabled through the application.

Further, the oral irrigator can also be provided with indicator lights, including a red light and a green light. The first tank and second tank can be provided with water level sensors. When the liquid in the first tank or second tank is nearly depleted, the water level sensor can be triggered, causing the red light to blink and the voice module to issue a first voice alert, such as “low water level”. During the charging of the oral irrigator, the indicator light can remain steadily red, and when the oral irrigator is fully charged, the indicator light can turn steadily green. When the power of the oral irrigator is low, the indicator light can flash red, and the voice module issues a second voice prompt, such as “low power”.

In the working state of the oral irrigator, a short press of the button will stop the operation of the oral irrigator. The second button can then be used to switch between the normal working mode and the spot spray working mode. Therefore, the oral irrigator can also switch modes during use.

The spray head 102 includes a normal spray head and a spot spray head, wherein a liquid sprayed from the normal spray head is in a form of a column, and a liquid sprayed from the spot spray head is in a form of a shower. The spot spray head can spray onto the surface of the teeth, providing a larger cleaning range, maintaining the whiteness of teeth, preventing cavities, and better meeting contemporary needs. In the normal working mode, the oral irrigator is replaced with the normal spray head, and in the spot spray working mode, the oral irrigator is replaced with the spot spray head.

The oral irrigator of the present disclosure can achieve functions such as power on/off, mode switching, and spraying and pausing in manual mode through two buttons, utilizing fewer buttons to achieve multiple functions, making the body of the oral irrigator simple and reducing openings.

It should be understood that at least part of the aspects or features of the above-described embodiments, examples, or illustrations can be appropriately combined.

It can be understood that in the present disclosure, if the number of components or elements is not particularly limited, the quantity of components or elements can be one or more, where “more” refers to two or more. In cases where the quantity of components or elements shown in the drawings and/or described in the specification is, for example, two, three, four, or another specific quantity, such specific quantities are generally exemplary and non-restrictive and can be understood as multiple, i.e., two or more. However, this does not exclude the situation of one in the present disclosure.

In the present disclosure, unless otherwise explicitly stated or limited, terms such as “mount”, “assemble”, “interconnect”, “connect”, “couple”, “link”, “abut”, “communicate”, “conduct”, “fixed”, and “fasten” should be understood in a broad sense, for example, they can be direct or indirect. For example, regarding “connection”, it can be a fixed connection, a detachable connection, or an integral connection; it can be a mechanical connection, an electrical connection, a direct connection, an indirect connection through an intermediary, an internal communication between two components, or the interaction relationship between two components, unless explicitly stated or limited otherwise. For example, regarding “communication” or “conduction”, it can refer to direct communication/conduction or indirect communication/conduction via an intermediary. Those of ordinary skill in the art can understand the meanings of the above terms in the present disclosure according to specific situations.

In the present disclosure, unless explicitly stated or limited otherwise, phrases such as “one component is arranged on/mounted on/located in/accommodated in/placed inside another component” can refer to either of the following: a portion or majority of one component is within the other component, or one component is entirely contained within the other component.

Although the above embodiments are described in detail in the present disclosure, it is apparent to those skilled in the art that the present disclosure is not limited to the embodiments described in the specification. The present disclosure can be modified and implemented in alternative embodiments without departing from the essence and scope of the present disclosure as determined by the claims. Accordingly, the descriptions in the specification are intended for illustrative purposes and do not have any limiting implications for the present disclosure.

1. A control method of an oral irrigator, wherein the oral irrigator comprises a normal working mode and a spot spray working mode; the oral irrigator is capable of switching between the normal working mode and the spot spray working mode, wherein
in the normal working mode, the oral irrigator continuously sprays water; and
in the spot spray working mode, the oral irrigator sprays water in a pulsed manner, with a pause duration between two water sprays.

2. The control method of the oral irrigator according to claim 1, wherein the spot spray working mode comprises a manual mode and an automatic mode, and the oral irrigator is capable of switching between the manual mode and the automatic mode;
the oral irrigator is provided with a first button and a second button;
in the manual mode, when the second button is pressed, the oral irrigator sprays water, and when the second button is released, the oral irrigator stops spraying water; and
in the automatic mode, the oral irrigator automatically sprays water for a period of time, pauses for a period of time, and then automatically sprays water again, and a cycle repeats.

3. The control method of the oral irrigator according to claim 2, wherein in the normal working mode and the automatic mode, a short press of the first button stops the oral irrigator from spraying water.

4. The control method of the oral irrigator according to claim 2, wherein after the oral irrigator is powered on, a short press of the second button activates the normal working mode of the oral irrigator; and
after the oral irrigator is powered on, or after a short press of the first button in the normal working mode to stop spraying water, a double-click of the second button activates the spot spray working mode.

5. The control method of the oral irrigator according to claim 2, wherein in the spot spray working mode, the double-click of the second button enables the oral irrigator to switch between the manual mode and the automatic mode.

6. The control method of the oral irrigator according to claim 2, wherein the oral irrigator defaults to the manual mode when the spot spray working mode is activated.

7. The control method of the oral irrigator according to claim 1, wherein the oral irrigator comprises an indicator light assembly, and when the oral irrigator switches modes, the indicator light assembly is configured to indicate a result of a mode switch.

8. The control method of the oral irrigator according to claim 1, wherein the oral irrigator comprises a voice module, and when the oral irrigator switches modes, the voice module is configured to announce a result of a mode switch.

9. An oral irrigator, wherein the oral irrigator adopts the control method of the oral irrigator according to claim 1;
the oral irrigator comprises a first tank, a second tank, a selection valve, and a water pump, wherein the selection valve is connected to an inlet of the water pump;
in the spot spray working mode, the selection valve enables the water pump to communicate with the first tank; and in the normal working mode, the selection valve enables the water pump to communicate with the second tank.

10. The oral irrigator according to claim 9, wherein the oral irrigator comprises a spray head;
the spray head comprises a normal spray head and a spot spray head, wherein a liquid sprayed from the normal spray head is in a form of a column, and a liquid sprayed from the spot spray head is in a form of a shower; and
in the normal working mode, the oral irrigator is replaced with the normal spray head, and in the spot spray working mode, the oral irrigator is replaced with the spot spray head.

11. The oral irrigator according to claim 9, wherein the spot spray working mode comprises a manual mode and an automatic mode, and the oral irrigator is capable of switching between the manual mode and the automatic mode;
the oral irrigator is provided with a first button and a second button;
in the manual mode, when the second button is pressed, the oral irrigator sprays water, and when the second button is released, the oral irrigator stops spraying water; and
in the automatic mode, the oral irrigator automatically sprays water for a period of time, pauses for a period of time, and then automatically sprays water again, and a cycle repeats.

12. The oral irrigator according to claim 11, wherein in the normal working mode and the automatic mode, a short press of the first button stops the oral irrigator from spraying water.

13. The oral irrigator according to claim 11, wherein after the oral irrigator is powered on, a short press of the second button activates the normal working mode of the oral irrigator; and
after the oral irrigator is powered on, or after a short press of the first button in the normal working mode to stop spraying water, a double-click of the second button activates the spot spray working mode.

14. The oral irrigator according to claim 11, wherein in the spot spray working mode, the double-click of the second button enables the oral irrigator to switch between the manual mode and the automatic mode.

15. The oral irrigator according to claim 11, wherein the oral irrigator defaults to the manual mode when the spot spray working mode is activated.

16. The oral irrigator according to claim 9, wherein the oral irrigator comprises an indicator light assembly, and when the oral irrigator switches modes, the indicator light assembly is configured to indicate a result of a mode switch.

17. The oral irrigator according to claim 9, wherein the oral irrigator comprises a voice module, and when the oral irrigator switches modes, the voice module is configured to announce a result of a mode switch.
